(19) United States
(12) Patent Application Publication
(10) Pub. No.: US 2010/0304232 A1
(43) Pub. Date: Dec. 2, 2010

(54) FILTER HOUSING FOR A FUEL CELL

(75) Inventors: Verena HUECKER, Weinheim (DE); Dieter HINTENLANG, Absteinach (DE); Thomas FISCHER, Darmstadt (DE)

Correspondence Address: GROSSMAN, TUCKER, PERREAULT & PFLEGER, PLLC, 55 SOUTH COMMERICAL STREET, MANCHESTER, NH, 03101, US

(73) Assignee: CARL FREUDENBERG KG, Weinheim (DE)

(21) Appl. No.: 12/854,358

(22) Filed: Aug. 11, 2010

Related U.S. Application Data
(60) Provisional application No. 61/233,182, filed on Aug. 12, 2009.

(30) Foreign Application Priority Data
Apr. 9, 2009 (DE) 102009016739.0-45

(51) Int. Cl. H01M 8/04

(52) U.S. Cl. 429/410

(57) ABSTRACT

A housing for filtering the intake air of a fuel cell, comprising a housing bottom part and a housing top part, which together bound off a space, the space being divided by at least one filter element into a crude air space and a clean air space, both the housing bottom part and the housing top part being coordinated with an air admission port to carry intake air into the space or out from the space, wherein the housing works steadily and reliably after a no-problem installation, wherein the filter element is at least partly embedded in a sealing compound.

### CROSS-REFERENCE TO RELATED APPLICATIONS

This application claims the benefit of U.S. Provisional Application Ser. No. 61/233,182 filed Aug. 12, 2009.

### FIELD

The invention concerns a housing for filtering the intake air of a fuel cell, comprising a housing bottom part and a housing top part, which together bound off a space, the space being divided by at least one filter element into a crude air space and a clean air space, and both the housing bottom part and the housing top part being associated with an air admission port for taking the intake air into the space or out from the space.

The invention also concerns a housing for filtering the intake air of a fuel cell, comprising a housing bottom part or a housing top part, which together with a supplemental housing part bounds off a space, the housing bottom part or the housing top part being associated with an air admission port for carrying intake air, while the supplemental housing part contains a filter element and the supplemental housing part forms an open-flow surface, instead of an air admission port, across which the filter element extends.

The invention also concerns a housing top part or housing bottom part for use in a fuel cell layout, comprising an air admission port to a space and a filter element, which is partly embedded in a sealing compound and bounds off the space.

### BACKGROUND

Housings of the mentioned kind are already known from WO 2008/075 754 A1 and WO 02/22234 A2. The known housings accommodate filter elements which are supposed to filter particles and gases from an intake air flow for a fuel cell.

When filtering an intake air flow for a fuel cell, care must be taken to make sure no leaks or bypasses occur, through which unfiltered air may get into the fuel cell.

The precautions which must be taken for this often cause large expenses and complicate sealing designs. They often involve long fabrication time and large footprints. Therefore, there is a need for very compact, economical and gas-tight housings. In particular, when the housing bottom part and the housing top part are joined together a fixation must be assured in order to provide for a simple assembly of the housing.

### SUMMARY

Therefore, the invention provides a filter system for the intake air of a fuel cell that works with long-term reliability after a problem-free assembly.

Accordingly, the housing is characterized in that the filter element is at least partly embedded in a sealing compound.

The invention has found that a permanent and single-piece connection of the filter element to the housing by a sealing compound effectively prevents leaks and bypasses such as might occur by installing a loose filter element. Specifically, it has been found that a gas-leak-tight connection between filter element and housing top part or housing bottom part may be produced at the factory. Furthermore, it has been found that costly seals which increase the price of a housing may be eliminated. Therefore, with the housing of the invention, a tight system of housing bottom part, filter element and housing top part may be created after problem-free assembly.

Consequently, the problem mentioned above may be solved.

Instead of a housing bottom part or a housing top part, the invention specifies a supplemental housing part in which a filter element is contained. The supplemental housing part forms an open-flow, in particular a free surface instead of an air admission port, across which the enclosed filter element extends. In this way, air may more easily be taken in across the entire lateral surface of the filter element. The pressure loss on intake of air is very low and may be substantially reduced as compared to the above-described layout.

The housing top part and/or the housing bottom part may contain a filter element. This makes it possible to arrange two filter elements opposite each other and connected in series.

The supplemental housing part may be made from a housing top part or a housing bottom part, wherein the part having the air admission port is removed above the enclosed filter element, the supplemental housing part consists of a flange edge adjacent to an arched wall, wherein the arched wall tapers in the direction of another wall, and wherein one edge of the other wall is aligned with the surface of the filter element and bounds the surface. In this way, a supplemental housing part may be made very easily from a housing top part or housing bottom part and be connected to its corresponding opposite part.

The sealing compound may be in the form of a single or multiple-component sealing compound. Such a sealing compound may be processed without problem. In particular, the sealing compound may consist of polyurethane. Polyurethane is a sealing compound that may be worked without problem by injection molding or casting.

The filter element may be shaped as a flat filter with a bellows, whose valleys engage with struts on opposite sides of the housing. The struts prevent the sealing compound from seeping into areas of the filter element that should remain free of sealing compound. This optimizes the effective filter surface. Furthermore, the struts molded on the housing bottom part and/or housing top part stabilize the folds of the bellows.

The filter element may be contained in a pan. In this case, the filter element with its side strips may form part of a pan containing the filter element. The side strips then lie on the bottom of the pan and thus retain the sealing compound in a channel. The filter element is fixed by the struts so that even thin and runny adhesives do not seep out from the pan. In this way, one may avoid an edge all around on the housing.

The pan may be at least partly formed in a broadening or arching of the wall of the housing bottom part or housing top part. The pan allows the sealing compound to be contained. Furthermore, it means that the flow channel of the intake air is not decreased by the sealing compound. The walls of the housing top part that channel the intake air preferably align with the walls of the housing bottom part that channel the intake air.

This being said, at least one filter element is firmly joined to the housing bottom part. This configuration has the advantageous effect that the housing bottom part may be warehoused and worked on as a single piece together with the filter element. It is also conceivable that at least one filter element is firmly joined to the housing top part.

The filter elements may face each other and jointly divide the space into a crude air space and a clean air space. This filter arrangement corresponds to a serial connection of two filter elements. Two series connected filter elements heighten the filter efficiency. Furthermore, it is easy to make two separate filter elements separated from each other. They may have different functionality, namely, they may filter harmful acidic gases on the one hand and basic gases on the other. Finally, they may be adjusted differently in terms of their sorbent surface weights without problem. As a result, a distinct increasing of the sorbent surface weight may be achieved.

Yet another supplemental filter may be contained between the filter elements, which is preferably in the form of a flat filter, mat, electret filter, salt particle filter or other particle filter. In this way, one may achieve in particular an additional function, namely, a filtering of salts. The facing filter elements in this case each act as support grids. In this way, a third filter element is accommodated in a closed housing, namely, the supplemental filter.

A grid may be hooked up at the crude air side of at least one filter element. In this way, the filter element is protected against damage from larger particles, such as stones. This configuration is especially sensible when using a housing bottom part or housing top part as a single piece for flanging onto an existing layout. The housing top part or the housing bottom part, or in any case a half-shell of the housing, may be flanged onto an existing layout together with the captive filter element arranged on it.

This being said, it is possible to arrange a supplemental filter between the grid and the filter element, especially a salt particle filter. Salts which might significantly damage a fuel cell may be effectively filtered out from the intake air.

The filter elements and/or the supplemental filter may have gas-adsorbing and/or gas-absorbing sorbents. A sorbent may work both adsorbingly, namely, by physical sorption, and absorbingly, namely, by chemical sorption. A chemical filtration may be accomplished by a sorbent. Depending on the finish of the sorbent, acidic and/or basic gases may be filtered. This filtering prevents premature wear on the fuel cell due to the action of corrosive gases.

The sorbent may be configured as activated charcoal. Other sorbents that work by physisorption or chemisorption may be used. It is conceivable to use impregnated carbon, silicon dioxide, alumosilicates, aluminum oxides, or ion exchange resins, alone or in a mixture.

The filter element may be made from a nonwoven fabric and have gas-adsorbing and/or gas-absorbing sorbents. Therefore, the filter element may not only filter particles, but also harmful gases from the intake air. The nonwoven configuration allows for a problem-free adjustment of the porosity of the filter element. Furthermore, nonwoven fabrics are commercially available with no problem. The filter element may be multiple-ply, and several nonwoven layers may be laminated to each other. The lamination brings about a stabilization of the nonwoven fabric. Furthermore, the individual nonwoven layers may be given different filter functions. Advantageously, the nonwoven fabric may consist of synthetic fibers, especially thermoplastic ones.

Advantageously, one may use a filter element made from a nonwoven fabric having a different porosity on the inflow than on the outflow side. The inflow side may have larger, more open pores. This makes possible the buildup of a porous filter cake layer and, thus, high filter performance even under a large dust load. Such a filter element may consist of a nonwoven fabric that is compacted on one side by high-pressure fluid blasting. In this way, the different pore structures may be produced on the inflow side and the outflow side.

A projecting flange edge may be formed on the housing bottom part and/or on the housing top part and/or on the supplemental housing part. Thanks to the flange edge, the housing bottom part and the housing top part or a housing top part or housing bottom part and the supplemental housing part may be joined mechanically or physically and gas-tight to each other. It is conceivable for the flange edges to be glued, ultrasound welded or laser welded. The flange edges may also be pressed together by a rail encircling both of them.

In one flange edge or in both flange edges there may be formed oblong holes. Oblong holes enable the housing to be joined to another piece of equipment in such a way that it may be shifted. In particular, when the air admission ports are connected by hoses, the housing may be shifted relative to another piece of equipment. Thanks to the oblong holes, the entire housing may be shifted along the oblong holes, while bolts are passed through the oblong holes to make the connection.

The housing top part and the housing bottom part may have the identical construction. This enables a low-cost fabrication of the housing and a favorable warehouse stocking of parts for the housing.

If two identical filter elements are contained in one housing top part or housing bottom part, a fixation is achieved. A malfunction due to abrasion of gas-adsorbing and/or gas-absorbing sorbents may be prevented by arranging a particle-trapping filter element at the outflow side. If only one filter element is contained in a housing top part or housing bottom part, a marking may ensure the fixation.

The housing may be made from plastic. Plastics are relatively inexpensive and may easily be worked and softened by ultrasound welding or laser welding so as to enter into an intimate bonding with another material. It is conceivable to use polypropylene, polyamide, ABS (acrylonitrile-butadiene-styrene), PS (polystyrene) or polyethylene as the plastic.

A housing top part or a housing bottom part may be flanged onto an existing fuel cell layout as a unified and isolated structural part, namely, as a half-shell. In order to avoid repetition in regard to the inventive activity, refer to the remarks on the housing as such.

All features of the housing top parts or housing bottom parts and filter elements that have been described in relation to the housing may also be part of an isolated housing top part or housing bottom part.

In particular, the filter element may be contained in a pan, the pan being formed as a broadening or arching of the wall of the housing top part or housing bottom part, and the filter element has side strips on either side, which abut against the bottom of the pan, and the side strips together with the pan form a channel in which the sealing compound is contained, while the side strips are glued to the sealing compound and joined by this tightly to the housing top part or the housing bottom part, and the sealing compound is arranged all around. Thanks to this, a commercially available, edge-reinforced filter element may be tightly inserted into a housing top part, housing bottom part, or supplemental housing part.

This being said, the filter element may be shaped as a flat filter with bellows, whose fold valleys engage with struts on the housing side.

There are various ways of embodying and modifying the teaching of the present invention in advantageous manner. For this, refer to the following explanation of preferred exemplary embodiments of the teachings of the invention by means of the drawing.

In connection with the explanation of the preferred exemplary embodiments by means of the drawings, preferred configurations and modifications of the teaching will also be discussed in general.

### BRIEF DESCRIPTION OF THE DRAWINGS

The description herein makes reference to the accompanying drawings in which:

FIG. 1 is a sectional diagram of a housing top part.

FIG. 1a is a sectional diagram showing the filter element contained in the sealing compound, schematically.

FIG. 1b is a schematic and perspective view of a housing top part with a filter element surrounded by the sealing compound.

FIG. 2 is a perspective view of the housing top part with a flange edge in which oblong holes are formed.

FIG. 3 is a perspective view of a housing with a housing bottom part and a housing top part per FIG. 2, whose air admission ports project in a common direction.

FIG. 4 is a perspective view of a housing with a housing bottom part and a housing top part per FIG. 2, whose air admission ports project in opposite directions.

FIG. 5 is a perspective view of another housing top part with a flange edge in which oblong holes are formed.

FIG. 6 is a perspective view of a housing with a housing bottom part and a housing top part per FIG. 5, whose air admission ports project in a common direction.

FIG. 7 is a perspective view of a housing with a housing bottom part and a housing top part per FIG. 5 whose air admission ports project in opposite directions.

FIG. 8 is a schematic sectional view of a housing top part in which a filter element with a grid is contained.

FIG. 9 is a schematic sectional view of a housing in which a filter element is contained.

FIG. 10 is a schematic sectional view of a housing in which two serially connected and facing filter elements are contained.

FIG. 11 is a perspective view of a housing that has a housing top part or a housing bottom part with an air admission port and a supplemental housing part without air admission port.

FIG. 12 is another perspective view of the housing per FIG. 11.

FIG. 13 is another perspective view of the housing per FIG. 11.

FIG. 14 is another perspective view of the housing per FIG. 11.

### DETAILED DESCRIPTION

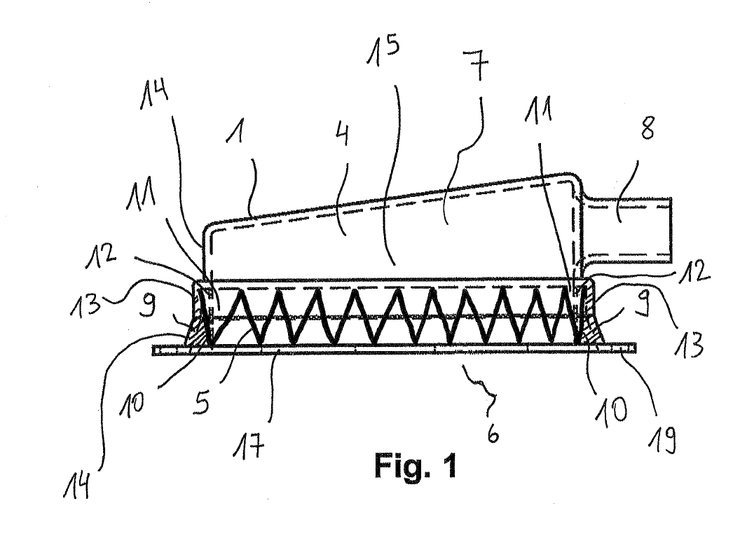

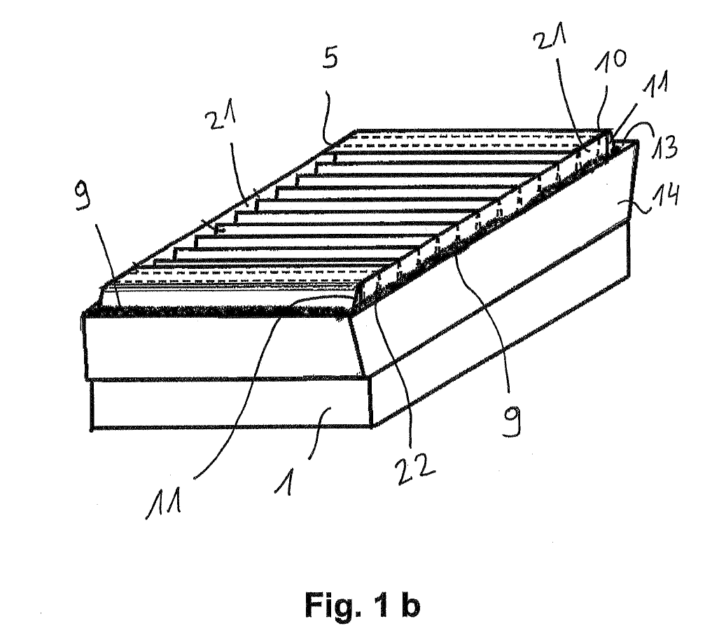

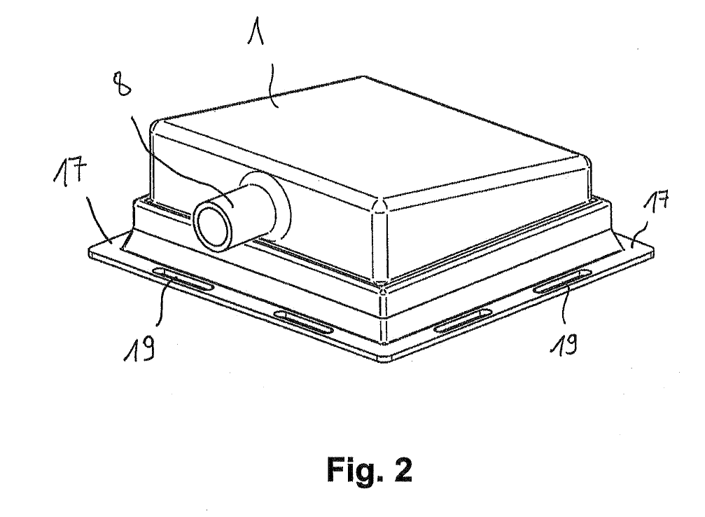

FIG. 1 shows a housing top part 1 for a housing 2 per FIG. 3 or FIG. 4 for filtering the intake air of a fuel cell. The housing 2 comprises a housing bottom part 3 and a housing top part 1, which together bound off a space 4, the space 4 being divided by at least one filter element 5 into a crude air space 6 and a clean air space 7 and both the housing bottom part 3 and the housing top part 1 being associated with an air admission port 8′ and 8 to carry intake air into the space 4 or out from the space 4. The housing 2 may be characterized in that the filter element 5 may be at least partly embedded in a sealing compound 9. Specifically, the edge region 10 of the filter element 5 may be embedded in the sealing compound 9 by its periphery. This ensures a gas leak tight and particle tight separation of the crude air space 6 from the clean air space 7.

The sealing compound 9 may comprise polyurethane. Polyurethane is a sealing compound that may be worked without problem by injection molding or casting. The filter element 5 is permanently and captively connected to the housing top part 1.

The filter element 5 may be shaped as a flat filter with a zig-zag folded bellows, the valleys 11 of whose folds engage with struts 12 at the housing side. The struts 12 prevent the sealing compound 9 from running out and getting into areas of the filter element 5 that should remain free of sealing compound 9. This optimizes the effective filter surface. Furthermore, the struts 12 formed on the housing top part 1 stabilize the folds of the bellows. This is shown especially clearly in FIG. 1a. The sealing compound 9 may enclose the last fold walls of the filter element 5 and bonds them in.

The filter element 5 may be contained in a pan 13. The pan 13 may be formed in a broadening or arching of the wall 14 of the housing top part 1. The filter element 5 may have side strips 21 on both sides, which abut against the bottom of the pan 13. The side strips 21 together with the pan 13 may form a channel 22 in which the sealing compound 9 is contained, thereby gluing the side strips 21 to the sealing compound 9 and being tightly connected to the housing top part 1. The sealing compound 9 may be arranged all around. This is shown especially clearly in FIG. 1b.

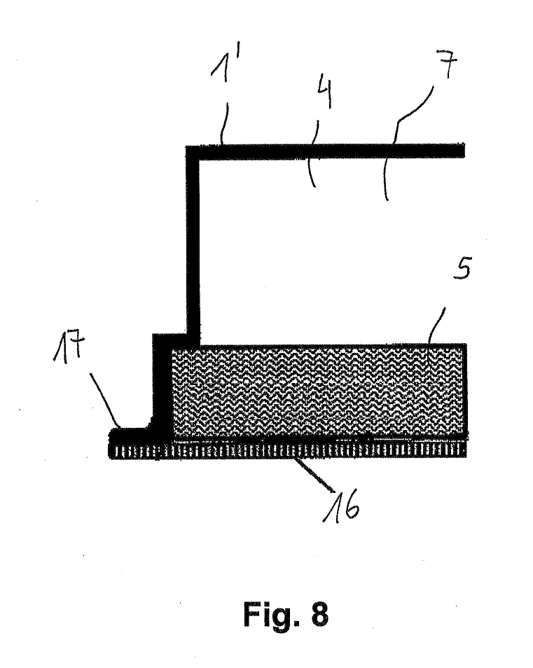

The pan 13 may allow the sealing compound 9 to be contained. Furthermore, it may have the effect of not decreasing the flow channel 15 of the intake air due to the sealing compound 9. The walls 14 of the housing top part 1 that convey the intake air may be flush with the air-conveying walls 14 of the housing bottom part 3. This is shown analogously in FIG. 10.

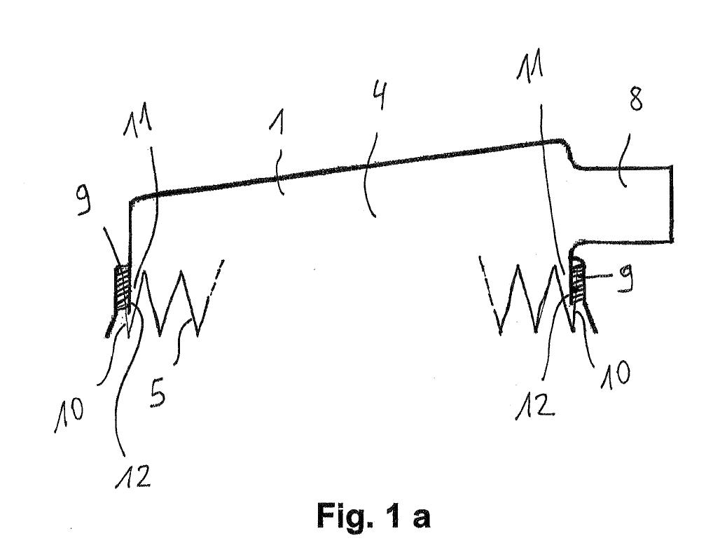

FIG. 2 shows a perspective view of the housing top part 1 of FIG. 1. FIG. 3 shows a housing 2 comprising a housing top part 1 and a similarly constructed housing bottom part 3. The air admission ports 8, 8′ may project in the same direction from the housing 2.

FIG. 4 shows a housing 2 comprising a housing top part 1 per FIG. 1 and a similarly constructed housing bottom part 3. The air admission ports 8, 8′ may project in opposite direction from the housing 2.

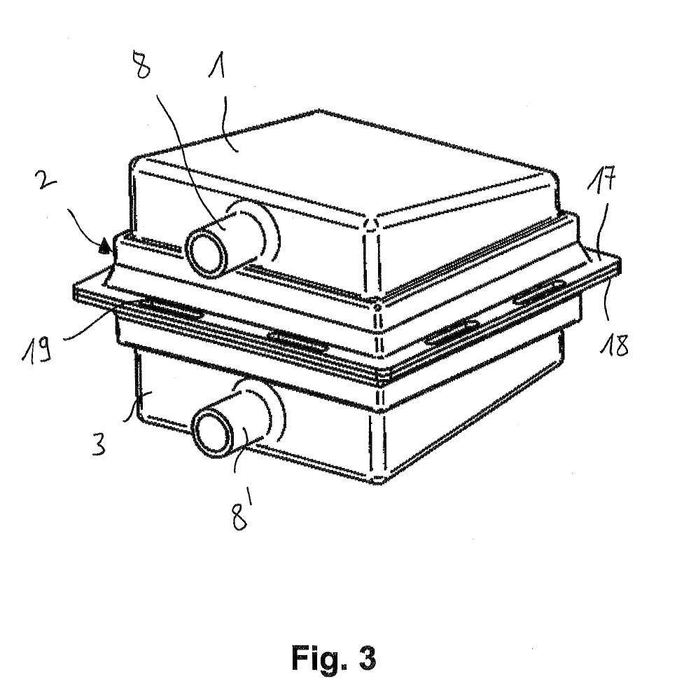

FIG. 5 shows a perspective view of another housing top part 1′, which has an essentially cuboid base body. For larger volume flows, it may be advantageous not to have the housing top part 1′ slanting.

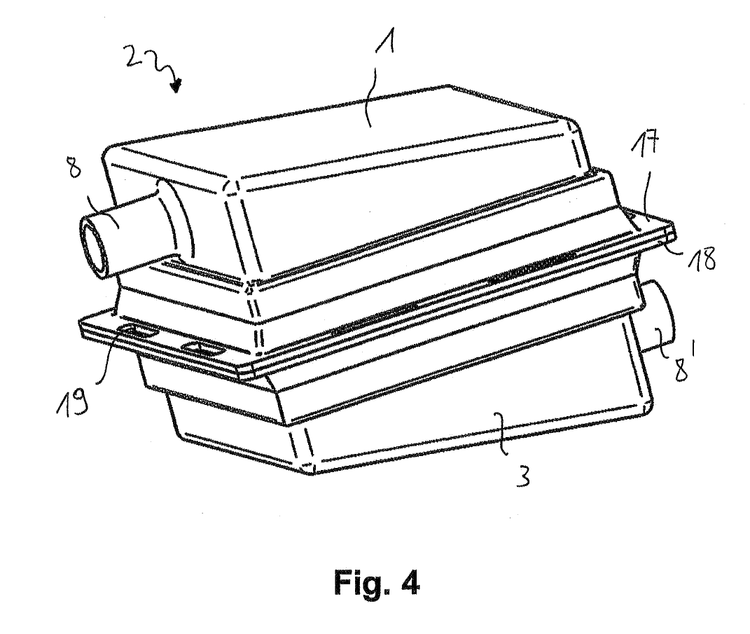

FIG. 6 shows a housing 2′ comprising a housing top part 1′ and a similarly constructed housing bottom part 3′. The air admission ports 8″, 8′″ may project in the same direction from the housing 2′.

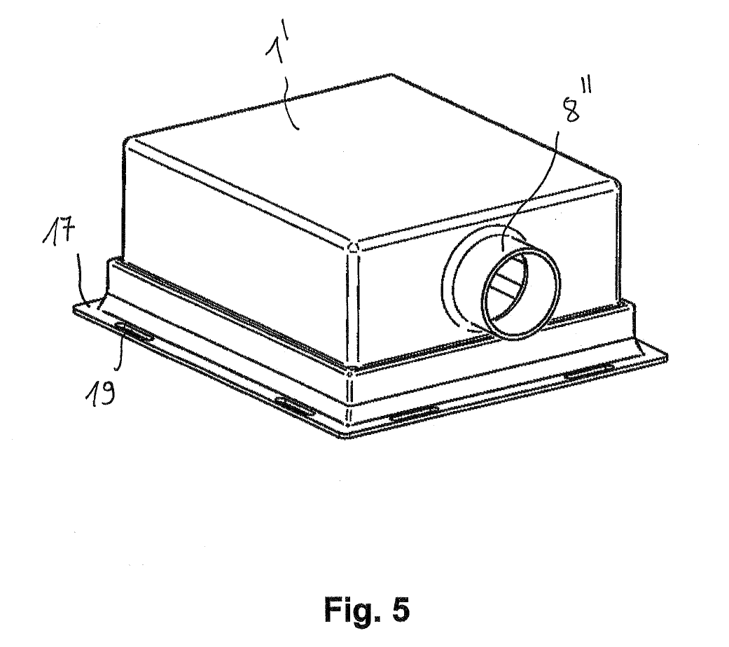

FIG. 7 shows a housing 2′ comprising a housing top part 1′ and a similarly constructed housing bottom part 3′. The air admission ports 8″, 8′ may project in opposite direction from the housing 2′.

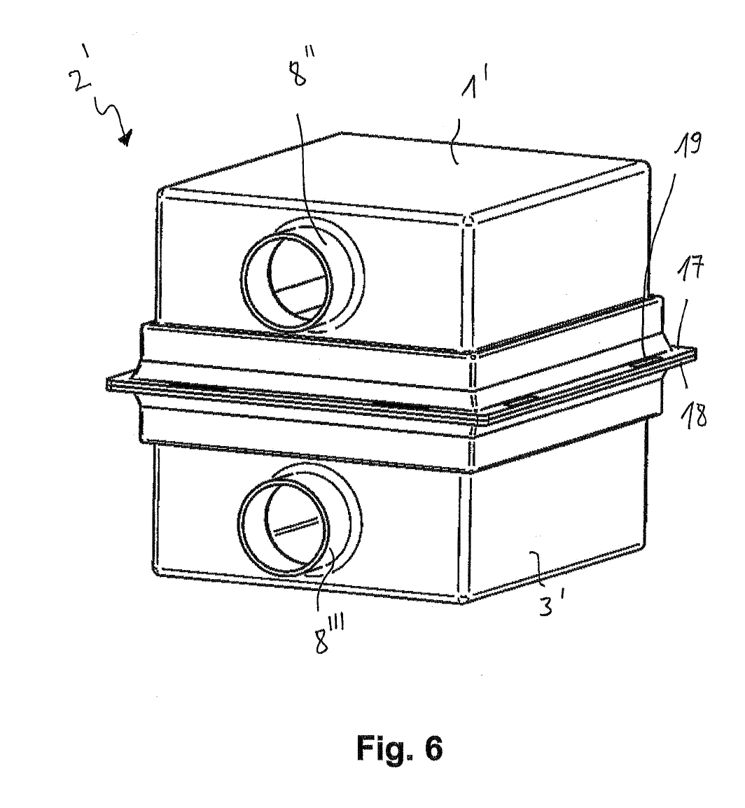

FIG. 8 shows in schematic view the housing top part 1′, in which a filter element 5 may be contained. The filter element 5 may have a grid 16 placed in front of it at the crude air side. In this way, the filter element 5 may be protected against damage from larger particles such as stones.

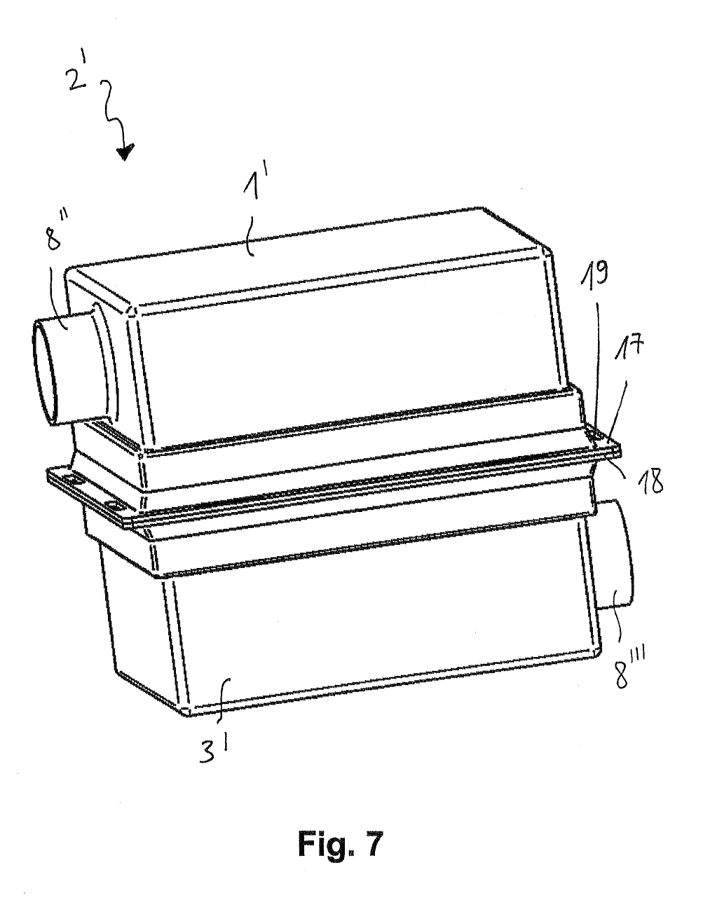

FIG. 9 shows the housing 2′ with a filter element 5 contained between the housing top part 1′ and the housing bottom part 3′.

In FIG. 10 there are two filter elements 5, 5a facing each other and together dividing the space 4 into a crude air space 6 and a clean air space 7. This filter arrangement corresponds to a serial connection of two filter elements 5, 5a and may enhance the filter efficiency.

The filter element 5, 5a may be made from a nonwoven fabric and has gas-adsorbing and/or gas-absorbing sorbents. The filter element 5, 5a may therefore filter not only particles, but also harmful gases from the intake air.

On the housing top parts 1, 1′ in the figures described here there may be formed a projecting flange edge 17. On the housing bottom parts 3, 3′ in the figures described here there may be formed a projecting flange edge 18. Thanks to the flange edges 17, 18, the housing bottom part 3, 3′ and the housing top part 1, 1′ may be mechanically or materially joined gas-tight to each other. It is conceivable for the flange edges 17, 18 to be glued, ultrasound welded, or laser welded.

In the flange edges 17, 18 there may be formed oblong holes 19, 20. The oblong holes 19, 20 may allow the housing 2, 2′ to be joined to another piece of equipment and still be able to shift. The oblong holes 19, 20 may be aligned with each other.

The housing top parts 1, 1′ described here and their corresponding housing bottom parts 3, 3′ may be identical in construction. This may allow for a fixation when putting together the housing 2, 2′ for a fuel cell as described here.

In FIGS. 1 to 10, the same reference numbers described the same structural parts for the housing 2, 2′ described here.

The air admission ports 8, 8′, 8″, 8′″ in other embodiments may be formed slanting relative to each other at any given angles.

FIG. 1, FIG. 1a and FIG. 1b show a housing top part 1 for use in a fuel cell layout or a housing of the kind described here, comprising an air admission port 8 to a space 4 and a filter element 5, which is embedded in a sealing compound 9 and bounds off the space 4. The filter element 5 may be contained in a pan 13, the pan 13 being formed in a broadening or arching of the wall 44 of the housing top part 1, while the filter element 5 may have side strips 21 on both sides, which abut against the bottom of the pan 13, and the side strips 21 along with the pan 13 may form a channel 22, in which the sealing compound 9 may be contained, while the side strips 21 may be glued to the sealing compound 9 and bonded by it tightly to the housing top part 1, and the sealing compound 9 may be arranged all around. The filter element 5 may be formed as a flat filter with bellows, the valleys of whose folds 11 engaging with struts 12 on the housing side.

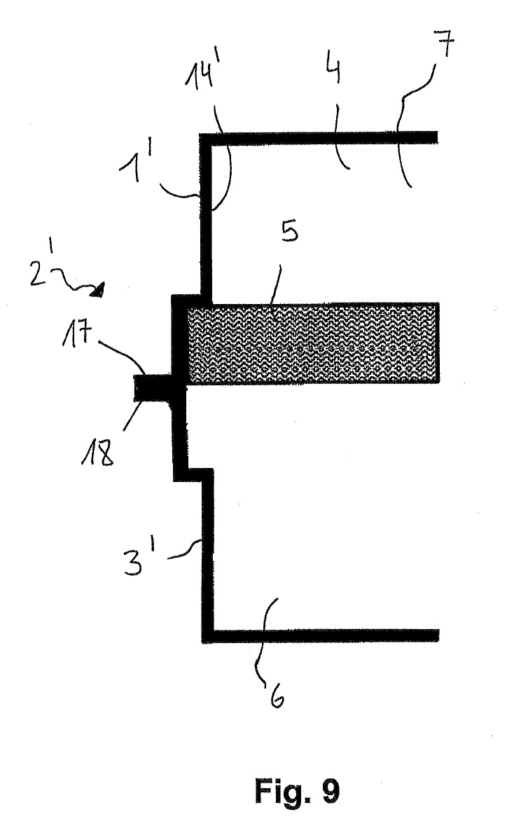

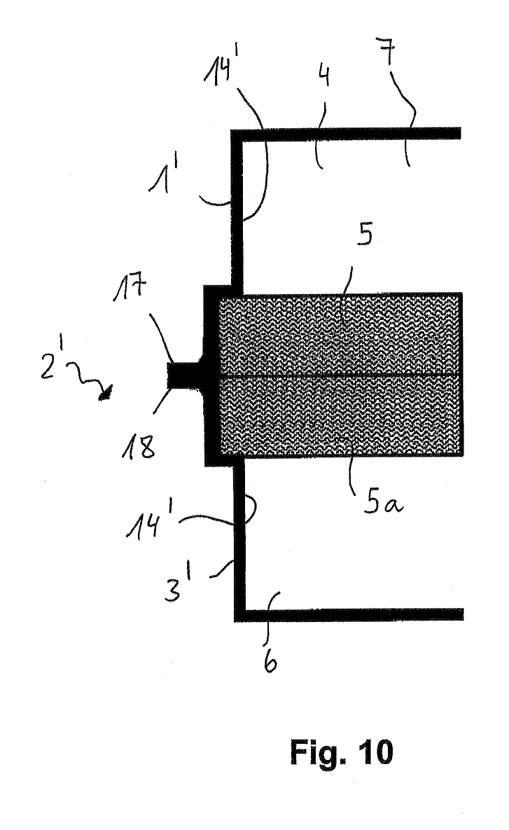

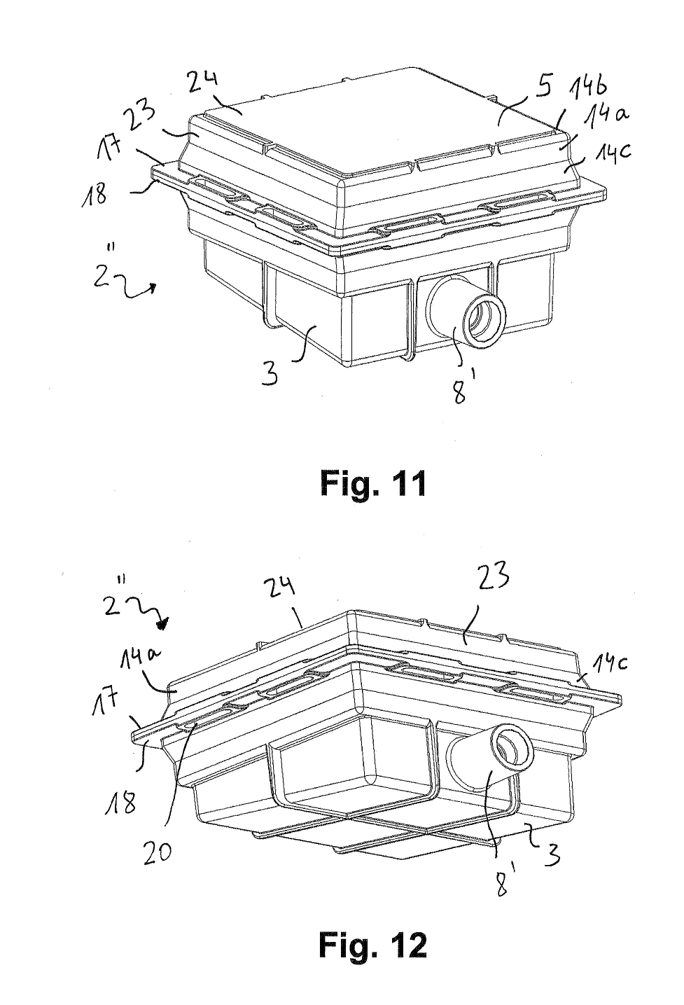

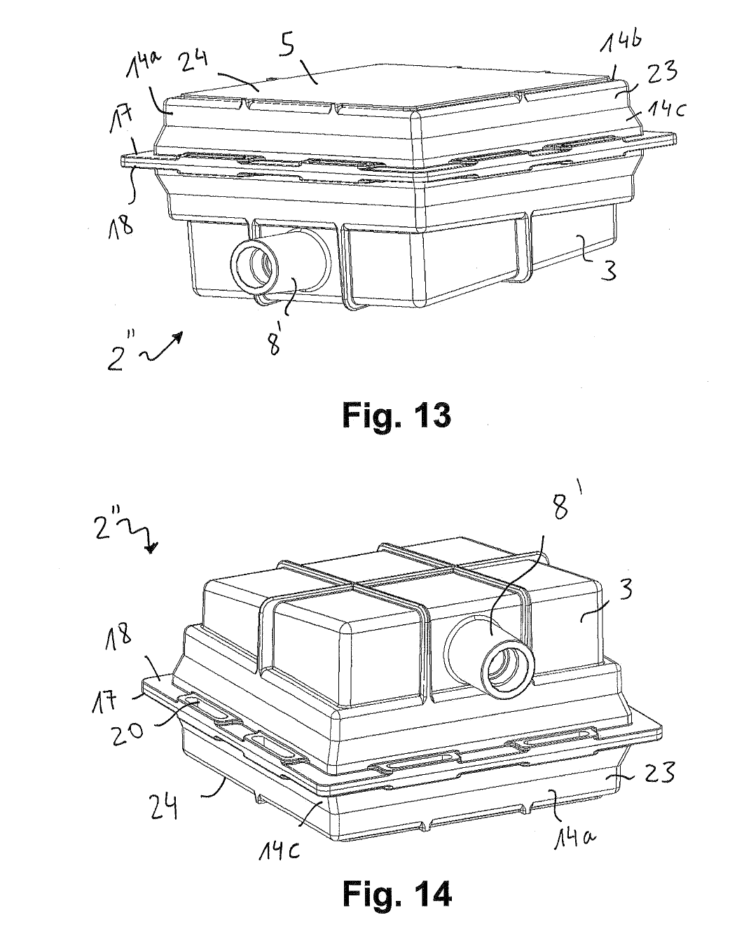

FIGS. 11 to 14 show in perspective view a housing 2″ for filtering the intake air of a fuel cell, comprising a housing bottom part 3, which together with a supplemental housing part 23 may bound off a space 4, while the housing bottom part 3 may be coordinated with an air admission port 8′ for channeling the intake air, while the supplemental housing part 23 may contain a filter element 5, and the supplemental housing part 23 may form a free, open-low surface 24 instead of an air admission port, across which the contained filter element 5 may extend. The filter element 5 may be embedded in a sealing compound 9. A filter element 5a may be contained in the housing bottom part 3′.

The supplemental housing part 23 may be made from a housing top part 1, the part having the air admission port 8 being removed above the contained filter element 5.

Specifically, the supplemental housing part 23 may comprise the flange edge 17, adjacent to which is the arched wall 14c, while the arched wall 14c tapers in the direction of another wall 14a. The edge 14b of the other wall 14a may be flush with the surface of the filter element 5 and bound off the surface 24.

As for other advantageous embodiments and modifications of the teaching of the invention, reference is made to the general portion of the specification.

Finally, it should be very particularly emphasized that the aforementioned exemplary embodiments serve merely to explain the teaching of the invention, but do not limit it to these exemplary embodiments.

What is claimed is:

1. A housing for filtering the intake air of a fuel cell, comprising a housing bottom part and a housing top part, which together bound off a space, the space being divided by at least one filter element into a crude air space and a clean air space, wherein both the housing bottom part and the housing top part are associated with an air admission port to carry intake air into the space or out from the space, wherein the filter element is at least partly embedded in a sealing compound.

2. A housing for filtering the intake air of a fuel cell, comprising a housing bottom part and a housing top part, which together with a supplemental housing part bound off a space, wherein the housing bottom part or the housing top part is associated with an air admission port to carry intake air, wherein the supplemental housing part contains a filter element and wherein the supplemental housing part forms an open-flow surface instead of an air admission port, across which the enclosed filter element extends, wherein the filter element is at least partly embedded in a sealing compound.

3. The housing according to claim 1, wherein the at least one filter element is contained in the housing top part and/or in the housing bottom part.

4. The housing according to claim 2, wherein the supplemental housing part is made from a housing top part or a housing bottom part, in that the part having the air admission ports is removed above the contained filter element, and the supplemental housing part comprises a flange edge adjacent to an arched wall, while the arched wall tapers in the direction of another wall, and one edge of the other wall is flush with the surface of the filter element and bounds the surface.

5. The housing according to claim 1, wherein the sealing compound is in the form of a single or multiple-component sealing compound.

6. The housing according to claim 1, wherein the at least one filter element is in the form of a flat filter with a bellows and including folds having valleys, the valleys of whose folds engage with struts at the housing side.

7. The housing according to claim 1, wherein the at least one filter element is contained in a pan.

8. The housing according to claim 1, wherein the at least one filter element is firmly joined to the housing bottom part.

9. The housing according to claim 1, wherein the at least one filter element is firmly joined to the housing top part.

10. The housing according to claim 8, wherein two filter elements face each other and jointly divide the space into a crude air space and a clean air space.

11. The housing according to claim 1, wherein the at least one filter element includes a grid at the crude air side.

12. The housing according to claim 1, wherein the at least one filter element is associated with a supplemental filter.

13. The housing according to claim 1, wherein the at least one filter element is made from a nonwoven fabric and has gas-adsorbing and/or gas-absorbing sorbents.

14. The housing according to claim 1, wherein a projecting flange edge is formed on the housing bottom part and/or on the housing top part and/or on the supplemental housing part.

15. The housing according to claim 14, wherein oblong holes are formed in the flange edge.

16. The housing according to claim 1, wherein the housing top part and the housing bottom part are structurally identical to each other.

17. A housing top part or housing bottom part for use in a fuel cell layout, comprising an air admission port to a space and a filter element, the filter element is at least partly embedded in a sealing compound and bounds off the space.

18. The housing top part or housing bottom part according to claim 17, wherein the filter element has a grid at the crude air side.

19. The housing top part or housing bottom part according to claim 17, wherein the filter element is contained in a pan having a bottom, wherein the pan is formed in a broadening or arching of the wall of the housing top part or housing bottom part, and the filter element has side strips on either side that abut against the bottom of the pan, while the side strips together with the pan form a channel in which the sealing compound is contained, and the side strips are glued to the sealing compound and tightly connected by this to the housing top part or to the housing bottom part and the sealing compound is arranged all around.

20. The housing top part or housing bottom part according to claim 17, wherein the filter element is formed as a flat filter with a bellows and folds including valleys, the valleys of whose folds engage with struts at the housing side.
